(19) United States
(12) Patent Application Publication
(10) Pub. No.: US 2008/0227074 A1
(43) Pub. Date: Sep. 18, 2008

(54) CORRELATED ELECTRONIC NOTEBOOK AND METHOD OF DOING THE SAME

(76) Inventor: Byron Johnson, Chicago, IL (US)

Correspondence Address: HOLLAND & KNIGHT LLP, 10 ST. JAMES AVENUE, 11th Floor, BOSTON, MA, 02116-3889, US

(21) Appl. No.: 11/928,279

(22) Filed: Oct. 30, 2007

Related U.S. Application Data
(60) Provisional application No. 60/894,535, filed on Mar. 13, 2007.

(51) Int. Cl. G09B 5/00

(52) U.S. Cl. 434/307 R

(57) ABSTRACT

An electronic notebook, method, and computer program product for providing an electronic book accessible by a user using a computing device, and providing an electronic notebook for storing at least one user generated entry. The at least one user generated entry is correlated with at least a portion of the electronic book.

### CROSS-REFERENCE TO RELATED APPLICATIONS

This application claims the benefit of U.S. provisional patent application Ser. No. 60/894,535, filed Mar. 13, 2007, the entire disclosure of which is incorporated by reference.

### FIELD OF THE INVENTION

The present disclosure relates to learning tools, and more specifically to learning tools for correlating electronic notes to an electronic book.

### BACKGROUND

Many tools and programs exist for helping students learn. Often, these tools and programs involve attending special learning sessions with tutors. In today's busy world in which both parents often work, there exists a need for such tools that are accessible from the home.

Additionally, different students require different types of help. For some students, reading from a lengthy text can be an intimidating task. There exists a need for learning tools that are configurable to the needs of individual students.

Further, some students may understand their notes from a lesson best if they can reference the specific text to which the notes relate. And a teacher may best be able to help such students learn if they can comment and ask questions directed at specific text or notes. Thus, there exists a need for a notebook that correlates to the text to which it is related.

### SUMMARY

According to one implementation, a method may include providing an electronic book accessible by a user using a computing device, and providing an electronic notebook for storing at least one user generated entry. The method may further include correlating the at least one user generated entry with at least a portion of the electronic book.

One or more of the following features may be included. The electronic book may be provided in at least one of an audio or a text based format. Similarly, the at least one user generated entry may be at least one of an audio, a video or a text based entry. The at least a portion of the electronic book is selected from the group consisting of a chapter, a paragraph, a sentence and a word.

The method may also include generating an electronic notebook outline from the at least one user generated entry. One of the electronic notebook or the electronic notebook outline may be made available to a third party for review. At least one entry generated by the third party may be associated with one of the electronic notebook or the electronic notebook outline, the at least one entry generated by the third party being accessible by the user.

According to another implementation, a computer program product residing on a computer readable medium may have a plurality of instructions stored thereon. The instructions, when executed by a processor, may cause the processor to perform operations including providing an electronic book accessible by a user on a computing device, and providing an electronic notebook for storing at least one user generated entry. The at least one user generated entry may be correlated with at least a portion of the electronic book.

One or more of the following features may also be included. The electronic book may be provided in at least one of an audio or a text based format. Similarly, the at least one user generated entry may be at least one of an audio, a video or a text based entry. The at least a portion of the electronic book is selected from the group consisting of a chapter, a paragraph, a sentence and a word.

The computer program product may also include instructions to perform operations including generating an electronic notebook outline from the at least one user generated entry. One of the electronic notebook or the electronic notebook outline may be made available to a third party for review. Comments generated by the third party may be stored in one of the electronic notebook or the electronic notebook outline and the user may be enabled to review the comments generated by the third party.

According to another implementation, a correlated electronic notebook may include a computing device. An electronic book may be accessible by a user on the computing device. An electronic notebook for storing at least one user generated entry may be included. The at least one user generated entry may be correlated with at least a portion of the electronic book.

One or more of the following features may be included. The electronic book may be provided in at least one of an audio or a text based format. Similarly, the at least one user generated entry may be at least one of an audio, a video or a text based entry. The at least a portion of the electronic book may be selected from the group consisting of a chapter, a paragraph, a sentence and a word.

An electronic notebook outline may be generated from the at least one user generated entry. One of the electronic notebook or the electronic notebook outline may be made available to a third party for review. The third party may generate comments associated with one of the electronic notebook or the electronic notebook outline for review by the user.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an electronic notebook correlation process accessible through a distributed computing network

FIG. 2 is a flowchart of a process executed by the electronic notebook correlation process of FIG. 1.

FIG. 3 is a screen shot of a user interface generated by the electronic notebook correlation process.

FIG. 4 is a screen shot of an electronic notebook summary window.

### DETAILED DESCRIPTION

### System Overview:

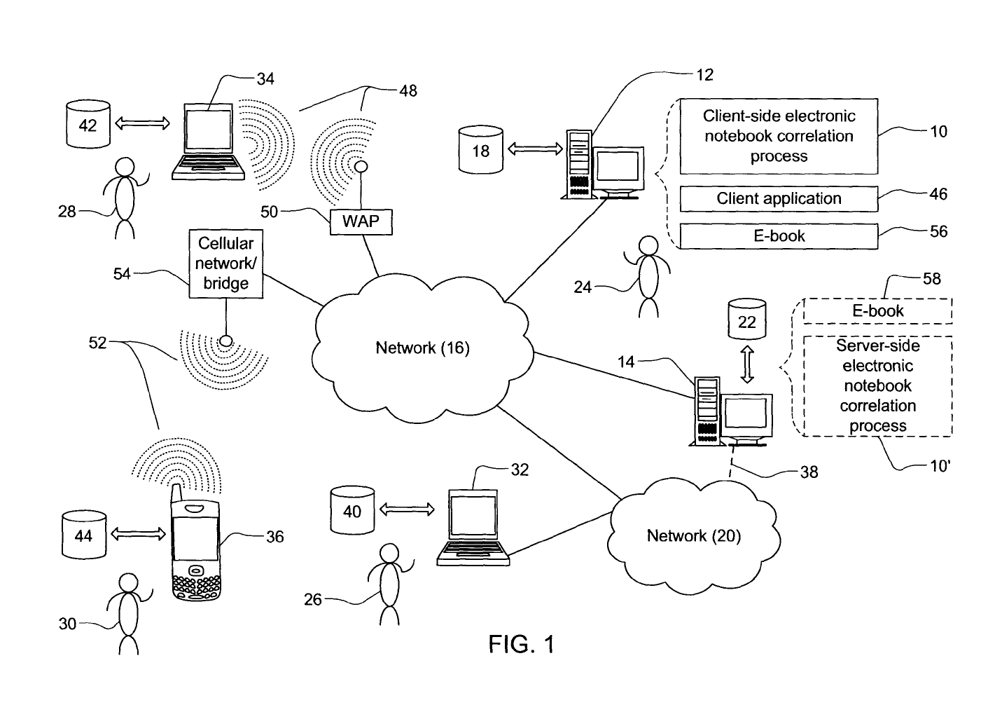

Referring to FIG. 1, there is shown client-side electronic notebook correlation process 10, that may reside on and may be executed by (in whole or in part) a computing device (e.g., client computer 12). There is also shown server-side electronic notebook correlation process 10′ that may reside on and may be executed by (in whole or in part) server computer 14. As will be discussed below in greater detail, electronic notebook correlation process 10, 10′ may enable one or more users to generate one or more entries, such as notes, comments, thoughts, remarks, and the like, relative to an electronic book. Electronic notebook correlation process 10 may associate the one or more entries with a particular portion of the electronic book, such as a chapter, page, paragraph, or word.

As mentioned above, client-side electronic notebook correlation process 10 may reside on and may be executed by (in whole or in part) a computing device (e.g., client computer 12) which may be coupled to network 16 (e.g., the Internet). The instruction sets and subroutines of electronic notebook correlation process 10, which may be stored on a storage device coupled to the computing device (e.g., storage devices 18), may be executed by one or more processors (not shown) and one or more memory architectures (not shown) incorporated into the computing device. The storage device (e.g., storage device 18) may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Server-side electronic notebook correlation process 10′ that may reside on and may be executed by (in whole or in part) server computer 14, which may be coupled to network 16. Examples of server computer 14 may include, but are not limited to: a single server computer, a series of server computers, a mini computer, and a mainframe computer, for example. Server computer 14 may execute a network operating system, examples of which may include but are not limited to: Microsoft Windows XP Server™; Novell Netware™; or Redhat Linux™, for example.

Server computer 14 may execute a web server application, examples of which may include but are not limited to: Microsoft IIS™, Novell Webserver™, or Apache Webserver™, that allows for HTTP (i.e., HyperText Transfer Protocol) access to server computer 14 via network 16. Server computer 14 may be coupled to one or more secondary networks (e.g., network 20), examples of which may include but are not limited to: a local area network; a wide area network; or an intranet, for example.

The instruction sets and subroutines of server-side electronic notebook correlation process 10′, which may be stored on storage device 22 coupled to server computer 14, may be executed by one or more processors (not shown) and one or more memory architectures (not shown) incorporated into server computer 14. Storage device 22 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally/alternatively electronic notebook correlation process may be a hybrid client-side/server-side application (e.g., using portions of both client-side electronic notebook correlation process 10 and server-side electronic notebook correlation process 10′). Accordingly, the manner in which the electronic notebook correlation process is accessed may vary depending on whether the electronic notebook correlation process is a client-side application, a server-side application, or a hybrid client-side/server-side application.

A user (e.g., user 24) may access electronic notebook correlation process 10 using the computing device (e.g., client computer 12) on which the client-side electronic notebook correlation process 10 is executed. Alternatively/additionally, users 24, 26, 28, 30 may access server-side electronic notebook correlation process 10′ through network 16 or through secondary network 20, using a computing device (e.g., client computer 12, notebook computer 32, laptop computer 34, and personal digital assistant 36). Server computer 14 (i.e., the computer that executes server-side electronic notebook correlation process 10′) may be coupled to network 16 through secondary network 20, as illustrated with phantom link line 38.

Users 24, 26, 28, 30 may access server-side electronic notebook correlation process 10′ using computing devices (e.g., client computer 12, notebook computer 32, laptop computer 34 and personal digital assistant 36), which may each execute a client application (e.g., client application 46) that may interface with server-side electronic notebook correlation process 10′ and facilitate unidirectional, or bidirectional transfer of data between the computing device and server computer 14.

The client application (e.g., client application 46) may be a web browser (e.g., Microsoft Internet Explorer™ and Netscape Navigator™, for example), a stand alone application, or an applet running within another program (e.g., Microsoft Internet Explorer™ and Netscape Navigator™, for example).

Computing devices, (e.g., client computer 12) may each execute an operating system, examples of which may include but are not limited to Microsoft Windows™, Microsoft Windows Mobile™, Redhat Linux™, or a custom operating system.

The various computing devices (e.g., client computer 12, notebook computer 32, laptop computer 34 and personal digital assistant 36) may be directly or indirectly coupled to network 16 (or network 20). For example, client computer 12 is shown directly coupled to network 16 via a hardwired network connection, and notebook computer 32 is shown directly coupled to network 20 via a hardwired network connection.

Laptop computer 34 is shown wirelessly coupled to network 16 via wireless communication channel 48 established between laptop computer 34 and wireless access point (i.e., WAP) 50, which is shown directly coupled to network 16. WAP 50 may be, for example, an IEEE 802.11a, 802.11b, 802.11g, Wi-Fi, and/or Bluetooth device that is capable of establishing wireless communication channel 48 between laptop computer 34 and WAP 50.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 16 via wireless communication channel 52 established between personal digital assistant 36 and cellular network/bridge 54, which is shown directly coupled to network 16.

An electronic book may be accessible by users 24, 26, 28, 30 using computing devices (e.g., client computer 12, notebook computer 32, laptop computer 34, and personal digital assistant 36). The electronic book may be locally stored relative to the computing devices (e.g., e-book 56 stored on storage device 18 coupled to client computer 12). The electronic book (e.g., e-book 56) may be stored on a removable media (e.g., a CD-ROM, DVD-ROM, or a removable flash memory device) accessible by the computing device (e.g., client computer 12), or may be stored on a non-removable media accessible the computing device. Alternatively, the electronic book may be remotely stored relative to the computing device. For example, e-book 58 may be stored on storage device 22 coupled to server computer 14. The computing devices (e.g., client computer 12, notebook computer 32, laptop computer 34, and personal digital assistant 36) may access e-book 58 through network 16, and/or network 20.

The electronic book (e.g., e-book 56, 58) may, for example, provide text, e.g., which may be visually rendered on client computer 12, audio (e.g., such as a “book on tape”) which may be played, e.g., through speakers (not shown) associated with client computer 12, as well as combinations of text and audio.

### The Electronic Notebook Correlation Process:

As discussed above, the electronic notebook correlation process may be a client-side application, a server-side application, or a hybrid client-side/server-side application. Accordingly, the following disclosure is applicable to all variants of the electronic notebook correlation process.

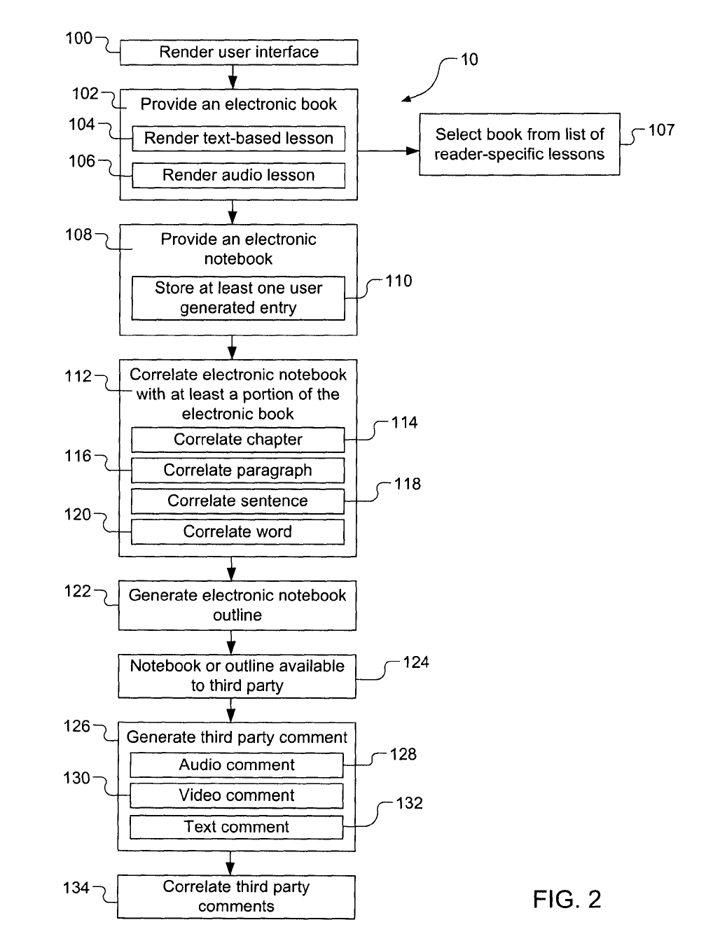

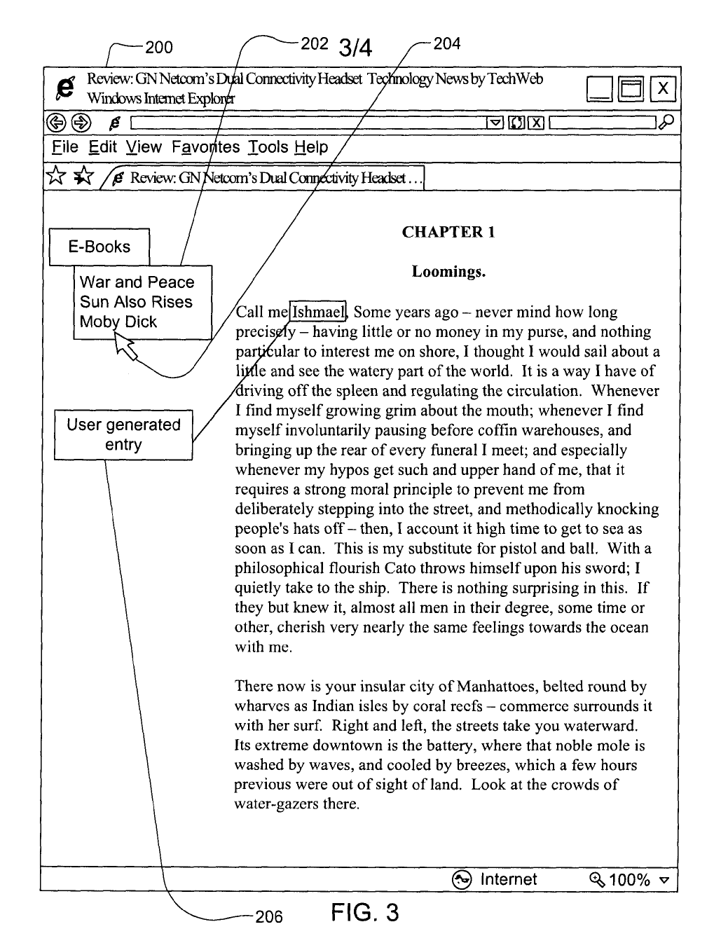

Referring also to FIGS. 2 and 3, electronic notebook correlation process 10, 10′ may be accessible by users (e.g., user 24, 26, 28, 30 of client computer 12, notebook computer 32, laptop computer 34 and personal digital assistant 36, respectively), and may enable the users to make notes, comments, and the like relative to an electronic book. Electronic notebook correlation process 10, 10′ may further correlate the notes and comments to specific portions of the electronic book, such as to specific chapters, pages, paragraphs, line, or works.

Electronic notebook correlation process 10, 10′ may render 100 user interface screen 200, which may enable a user to perform various tasks associated with taking notes related to a portion of electronic book 56, 58. Electronic notebook correlation process 10, 10′ may be a stand-alone program providing an application-specific user interface screen. Additionally/alternatively, electronic notebook correlation process 10 may be a module, plug-in, applet, or the like, and may operate within a client application environment (such as a web browser). In such an example, user interface screen 200 may be rendered 100 in the form of a webpage.

Through user interface screen 200, electronic notebook correlation process 10, 10′ may enable users to access 102 one or more electronic books (e.g., e-book 56, 58), for example, from a drop down menu 202 using screen pointer 204, which may be controlled by a pointing device, such as a mouse (not shown). E-book 56, 58 may include, but is not limited to, for example, a literature selection, a text book, a book or treatise on a specific subject or a journal article on which a user may wish to take notes. Electronic notebook correlation process 10, 10′ may render e-book 56, 58 in a variety of formats. Alternatively, the electronic book (e.g., e-book 56, 58) may be rendered by another application. For example, if e-book 56, 58 is a text-based electronic book, electronic notebook correlation process 10, 10′ may render 104 e-book 56, 58 in text format on a display of the computing device, as shown in FIG. 3. Alternatively, if e-book 56, 58 is an audio format electronic book, electronic notebook correlation process 10, 10′ may render 106 e-book 56, 58 in an audio format, enabling the user to listen to audio format e-book 56, 58. Furthermore, if e-book 56, 58 includes both text and audio, electronic notebook correlation process 10, 10′ may render 104, 106 both text and audio, e.g., enabling the user to read the text along with the audio output.

Electronic notebook correlation process 10, 10′ may enable the user to select 107 e-book 56, 58 from a list of available books. For example, in a teaching environment, a teacher may have chosen a number of books as a curriculum or lesson plan for the user. In this way, electronic books 56, 58 available to the user may be custom-tailored to individual students or for whole classes. Alternatively, e-book 56, 58 may be available to the user related to a research topic, or be for leisure reading or for participation in a book club.

Electronic notebook correlation process 10, 10′ may provide 108 an electronic notebook that may enable the user to store 110 one or more user generated entries. Electronic notebook correlation process 10, 10′ may store 110 the electronic notebook separately from e-book 56, 58, or the electronic notebook may be stored 110 as a part of electronic book 56, 58. For example, the user may generate entries such as notes, comments, or questions that may be stored 110 in an electronic file or document separate from e-book 56, 58. As such, the electronic notebook may be accessible separately from e-book 56, 58. Alternatively, the user may generate entries such as notes, comments, or questions that may be stored 110 by being incorporated into e-book 56, 58, e.g., appearing in the margin, as footnotes or annotations, within e-book 56, 58.

The at least one user generated entry may be correlated 112 to at least a portion of e-book 56, 58. For example, electronic notebook correlation process 10, 10′ may correlate the one or more user generated entries to a chapter 124, to a paragraph 116, to a sentence 118, or to a word 120. For example, the user may select the word “Ishmael” in the rendered portion of e-book 56, 58 using screen pointer 204 (shown in FIG. 3), and open entry dialog box 206 (for example by right-clicking on the work). The user may insert an entry, e.g., comments typed using the keyboard of the computing device, in entry dialog box 206.

Electronic notebook correlation process 10, 10′ may correlate 112 the user generated entry in entry dialog box 206 to the selected portion of e-book 56, 58. The correlation between the user generated entry and the selected portion of e-book 56, 58 may be accomplished, for example, by embedding a link in the relevant portion of e-book 56, 58 to the related user generated entry in the electronic notebook. Similarly, a link may be embedded in the user generated entry in the electronic notebook to the relevant portion of e-book 56, 58. In another example, a link may be embedded in both e-book 56, 58 and the electronic notebook, enabling the user to link back and forth between e-book 56, 58 and the electronic notebook. In still another example, the user generated entry may be stored 110 as an annotation in e-book 56, 58, e.g., appearing the margin of rendered 104 e-book 56, 58. In this manner, electronic notebook correlation process 10, 10′ may correlate 112 the user generated entry to the selected portion of e-book 56, 58 by physical proximity when the relevant portion of e-book 56, 58 is rendered.

The at least one user generated entry may be, for example, a question or a note about the at least a portion of the electronic book. For example, a user may generate an entry in the electronic notebook indicating that he did not understand a specific portion of the electronic book as a reminder to ask a question about it. Similarly, a user may generate an entry in the electronic notebook indicating that he needs to do further research related to what was discussed in that specific portion of the electronic book.

In addition, or as an alternative to, providing a text format entry, the user may provide one or more audio or video entry. For example, the user may find it easier to comment on a part of the electronic book by saying what he is thinking, rather than typing the comment. Similarly, the user may generate a video entry in the electronic notebook, e.g., using a web camera or the like.

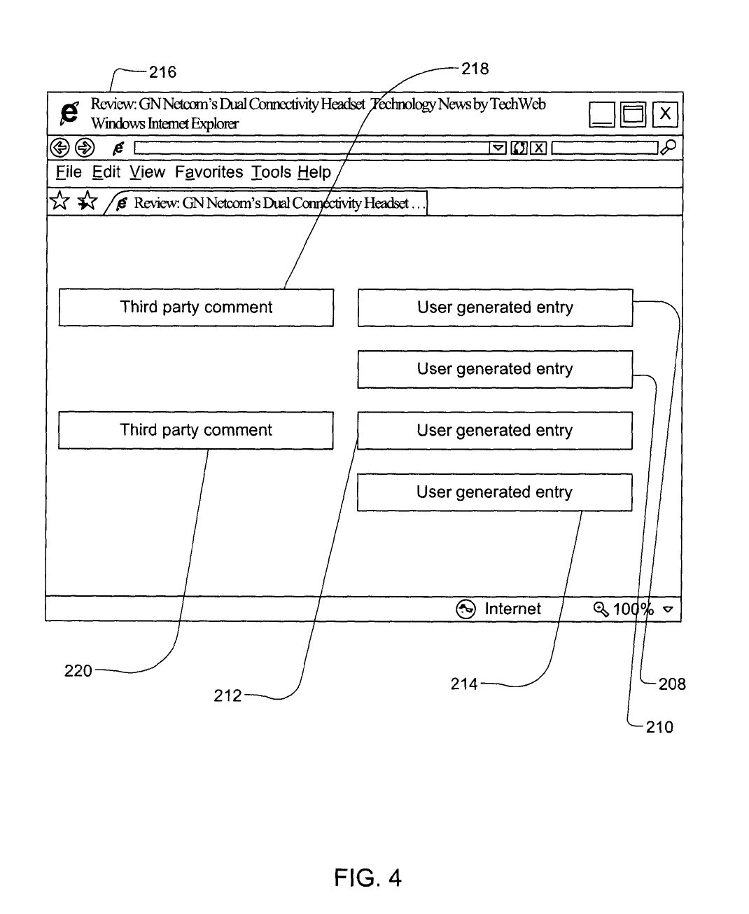

Continuing with the above-stated example, and with reference also to FIG. 4, electronic notebook correlation process 10, 10′ may generate 122 an electronic notebook outline based, at least in part, upon one or more user generated entries 208, 210, 212, 224. For example, one or more user generated entries 208, 210, 212, 224 may be organized into an outline format, e.g., in outline window 216. Alternatively, an outline summary of the one or more user generated entries may be generated, e.g., in which the user may rearrange or re-order the user generated entries 208, 210, 212, 224 without breaking the correlation to the selected portion of e-book 56, 58. The electronic notebook outline and summary may be, for example, helpful for organizing user generated entries 208, 210, 212, 224 if the electronic notebook is part of the electronic book.

Electronic notebook correlation process 10, 10′ may make 124 either the electronic notebook or the electronic notebook outline available to a third party (e.g., another of users 24, 26, 28, 30). For example, the electronic notebook and/or the electronic notebook outline may be transmitted to the third party for review. Additionally/alternatively, the third party may be notified (e.g., via email, instant message, voicemail, text message) that the electronic notebook and/or the electronic notebook outline may be accessed. The third party may, for example, access the electronic notebook and/or electronic notebook outline, e.g., through network 16, 20. The third party may view the electronic notebook or electronic notebook summary (for example, outline window 216) using a computing device (e.g., client computer 12, notebook computer 32, laptop computer 34 and personal digital assistant 36). In one such embodiment, electronic notebook correlation process 10, 10′ may store the electronic notebook or electronic notebook outline on server computer 14, which may be accessed by the third party, e.g., through network 16, 20. Consistent with the foregoing, a user who has completed an assigned book may make the electronic notebook or the electronic notebook outline available to a third party, such as a teacher who assigned the book, as a book report or a progress report. Similarly, if the electronic notebook has been kept in conjunction with research for a thesis, the electronic notebook or electronic notebook outline may be made available to the thesis advisor for review and comment, or as a progress report.

Electronic notebook correlation process 10, 10′ may enable 126 the third party to generate 126 one or more third party comments 218, 220 (e.g., as shown outline window 216 in FIG. 4) in the electronic notebook outline and/or the electronic notebook. Third party comments 218, 220 may be general comments and/or may be correlated to one or more user generated entries (e.g., user generated entries 208, 212). Third party comments may be made available for review by the user. For example, the third party may be a teacher, to whom the electronic notebook outline may be made available 124 (e.g., as a book report) by the user. The third party may be enabled 126 to generate one or more third party comment 218, 220 directed to the user, e.g., for the purpose of provoking more thought on a particular subject or to direct the user to another book of interest. Similarly, a third party, such as a thesis advisor, may be provided with access to the electronic notebook as a progress report. The third party thesis advisor may provide a comment for the purpose of directing user to another topic of research that would complement the thesis topic or to indicate that the user is going in the right direction regarding his research.

Electronic notebook correlation process 10, 10′ may enable the third party to generate one or more audio comment 128, video comment 130, or text based comment 132. Similar to the at least one user generated entry, it may be beneficial for the third party to comment in a particular format.

As mentioned above, electronic notebook correlation process 10 may correlate 134 third party comments 218, 220 to the electronic notebook (e.g., to user generated entries 208, 210, 212, 224). In one example, third party comments 218, 220 may be provided in a separate file or electronic document from the electronic notebook. A link may be embedded in one or more user generated entries 208, 210, 212, 224 in the electronic notebook outline and/or the electronic notebook to correlated third party comments 218, 220. Similarly, a link may be embedded in the user generated entry in the electronic notebook, which has been provided as a note in the margin, such as a footnote or annotation, in the electronic notebook. The link may correlate to the relevant third party comment 218, 220. In another example, a link may be embedded in both the electronic notebook and the third party comment. In such a case, the link may enable the user to navigate back and forth between the third party comment 218, 220 and the electronic notebook.

A number of implementations have been described. Nevertheless, it will be understood that various modifications may be made. Accordingly, other implementations are within the scope of the following claims.

What is claimed is:

1. A method comprising:
providing an electronic book accessible by a user using a computing device;
providing an electronic notebook for storing at least one user generated entry; and
correlating the at least one user generated entry with at least a portion of the electronic book.

2. The method of claim 1, wherein the electronic book is provided in at least one of an audio or a text based format.

3. The method of claim 1, wherein the at least one user generated entry is at least one of an audio, a video or a text based entry.

4. The method of claim 1, wherein the at least a portion of the electronic book is selected from the group consisting of a chapter, a paragraph, a sentence and a word.

5. The method of claim 1, further comprising generating an electronic notebook outline from the at least one user generated entry.

6. The method of claim 5, further comprising making one of the electronic notebook or the electronic notebook outline available to a third party for review.

7. The method of claim 6, further comprising associating at least one entry generated by the third party with one of the electronic notebook or the electronic notebook outline, the at least one entry generated by the third party being accessible by the user.

8. A computer program product residing on a computer readable medium having a plurality of instructions stored thereon which, when executed by a processor, cause the processor to perform operations comprising:
providing an electronic book accessible by a user on a computing device;
providing an electronic notebook for storing at least one user generated entry; and
correlating the at least one user generated entry with at least a portion of the electronic book.

9. The computer program product of claim 8, wherein the electronic book is provided in at least one of an audio or a text based format.

10. The computer program product of claim 8, wherein the at least one user generated entry is at least one of an audio, a video or a text based entry.

11. The computer program product of claim 8, wherein the at least a portion of the electronic book is selected from the group consisting of a chapter, a paragraph, a sentence and a word.

12. The computer program product of claim 8, further comprising instructions to perform operations including generating an electronic notebook outline from the at least one user generated entry.

13. The computer program product of claim 12, further comprising instructions to perform operations including making one of the electronic notebook or the electronic notebook outline available to a third party for review.

14. The computer program product of claim 13, further including instructions for storing comments generated by the third party in one of the electronic notebook or the electronic notebook outline and for enableing the user to review the comments generated by the third party.

15. A correlated electronic notebook comprising:
a computing device;
an electronic book accessible by a user on the computing device;
an electronic notebook for storing at least one user generated entry, the at least one user generated entry being correlated with at least a portion of the electronic book.

16. The correlated electronic notebook of claim 15, wherein the electronic book is provided in at least one of an audio or a text based format.

17. The correlated electronic notebook of claim 15, wherein the at least one user generated entry is at least one of an audio, a video or a text based entry.

18. The correlated electronic notebook of claim 15, wherein the at least a portion of the electronic book is selected from the group consisting of a chapter, a paragraph, a sentence and a word.

19. The correlated electronic notebook of claim 15, further comprising an electronic notebook outline generated from the at least one user generated entry.

20. The correlated electronic notebook of claim 19, wherein one of the electronic notebook or the electronic notebook outline is made available to a third party for review.

21. The correlated electronic notebook of claim 20, wherein the third party generates comments associated with one of the electronic notebook or the electronic notebook outline for review by the user.
